(19) United States
(12) Patent Application Publication
(10) Pub. No.: US 2015/0227679 A1
(43) Pub. Date: Aug. 13, 2015

(54) METHOD FOR GENERATING A GRAPHICAL 3D COMPUTER MODEL OF AT LEAST ONE ANATOMICAL STRUCTURE IN A SELECTABLE PRE-, INTRA-, OR POSTOPERATIVE STATUS

(71) Applicants: Lukas Kamer, Schindellegi (CH); Christoph Nötzli, Davos Platz (CH); Balazs Erdöhelyi, Filisur (CH)

(72) Inventors: Lukas Kamer, Schindellegi (CH); Christoph Nötzli, Davos Platz (CH); Balazs Erdöhelyi, Filisur (CH)

(73) Assignee: AO TECHNOLOGY AG, Chur (CH)

(21) Appl. No.: 14/414,367

(22) PCT Filed: Jul. 12, 2012
(86) PCT No.: PCT/CH2012/000165

§ 371 Date: Apr. 14, 2015

(51) Int. Cl. G06F 19/12

(52) U.S. Cl. CPC G06F 19/12

(57) ABSTRACT

A method for generating a graphical 3D computer model of anatomical structures in a selectable pre-, intra-, or postoperative status that includes: (A) receiving a preoperative first medical 3D image data set of anatomical structures to be treated of a patient; (B) generating a first graphical 3D computer model of the anatomical structures to be treated in the form of a digital data set using the data received in step (A); (C) receiving a second medical 2D or 3D image data set of the anatomical structures to be treated; (D) generating a second graphical 2D or 3D computer model of the anatomical structures to be treated in the form of a digital data set using the data received in step (C); and (E) carrying out an image registration process of the first graphical 3D computer model using the second graphical 2D or 3D computer model.

The invention relates to a method for generating a graphical three-dimensional (3D) computer model of at least one anatomical structure in a selectable pre-, intra-, or postoperative status according to the preamble of Claim 1.

In the surgical treatment of bone fractures and in the correction of bone malpositions, bone fragments are repositioned anatomically and attached in a stable manner in correct position using an appropriate osteosynthesis technique. However, problems can result from an undetected incorrect position of bone fragments and implants during the operation, or due to their secondary dislocation during the postoperative course. Thus, incorrect osteosynthesis due to anatomically incorrect repositioning of bone fragments, incorrect surgical technique, inappropriate implant selection and/or positioning thereof are to be avoided.

Bone fractures and bone malpositions are evaluated or planned routinely by means of different radiological imaging processes before, during, and also after the operation. Usually these procedures involve taking conventional X-rays, i.e., planar projection views. Particularly complex interventions are evaluated for diagnostic purposes using tomographic cross-sectional imaging views, preferably by computer tomography (CT). This occurs by analyzing its cross-sectional images or its three-dimensional computer models, preferably preoperatively, and also intra-, or postoperatively in the case of special problems.

However, to date the bone fragments and the osteosynthesis cannot be evaluated spatially in a conclusive manner during routine clinical operation over the entire course of the therapy. To achieve this, three-dimensional imaging processes such as CT would be required in all the therapy steps. As mentioned, this is indeed technically possible, but costs, reasons pertaining to radiation hygiene, artefact generation, and expenses for personnel, organization and technology so far have represented clear arguments against a routine spatial evaluation of the osteosynthesis in all the stages of the therapy.

From US-A 2011/0082367 REGAZZONI, a method is known for repositioning fragments of a fractured bone. This known method comprises the generation of 3D representations of bones and bone fragments on the basis of a digital data set acquired by CT of a fractured bone as well as of the contralateral healthy bone of a patient, wherein the 3D representation of the mirrored contralateral healthy bone is used as reference model for the relative position of the 3D representation of the repositioned bone fragments. Subsequently, the 3D representations of the proximal and distal bone fragments are made to coincide, in each case by means of a three-dimensional image registration, with the 3D representation of the reference model, and the configurations of the markers or anatomical landmarks are extracted at the proximal and at the distal bone fragments and transferred to the reference model. The relative positions of the markers or anatomical landmarks of the proximal and distal bone fragments that have been transferred to the reference model then make it possible to prepare a digital reference data set that can be used for the real repositioning of the bone fragments during the surgery. Using a C arm fluoroscope, in each case two in-situ medical images of the proximal and distal bone fragments of the patient positioned on the operating table are acquired preoperatively. From the respective two medical images, the three-dimensional positions of the markers or anatomical landmarks of the proximal and distal bone fragments are subsequently calculated relative to a local coordinate system, and therefrom the relative in-situ positions of the markers or anatomical landmarks of the proximal and distal fragments are calculated. Finally, by means of a comparison of the relative in-situ positions of the markers or anatomical landmarks with a digital reference data set, a set of alignment parameters is determined.

In this known method, no image registration of the preoperatively acquired in-situ medical images using the 3D representation of the bone or of the bone fragments used for the planning is required. However, since no such image registration is carried out, operation steps, implants and surgical instruments determined during the planning cannot be transferred to the in-situ situation.

The adequate anatomical repositioning of bone fragments including stable osteosynthesis is a key surgical concept in the treatment of fractures and in corrective osteotomies. However, especially in difficult situations, such as comminuted fractures with involvement of a joint or complex corrective osteotomies, this is not easy to achieve. In principle, errors can occur intraoperatively or they can manifest themselves only during the postoperative course. One possible source of error occurs when the bone repositioning was indeed carried out in a stable but anatomically incorrect manner and this was not detected during the operation. Furthermore, although the anatomy may in fact have been reestablished appropriately, implants come to lie in an incorrect position, for example, in the joint gap, which is not detected. A biomechanically insufficient osteosynthesis with dislocation of bone defects and/or osteosynthesis usually becomes apparent only during the postoperative course.

Thus, both in the treatment of a fracture and also in the case of bone malpositions, the osteosynthesis consisting of bone fragments and implants needs to be represented and planned better preoperatively and also to be monitored better intra- and also postoperatively, in the sense of a spatial, that is to say 3D, monitoring of the osteosynthesis construct throughout the entire course of the therapy.

Therefore, the invention is based on the problem of providing a method for generating a graphical 3D computer model which comprises at least the anatomical structures that are to be treated surgically or that have been treated, in a selectable pre-, intra-, or postoperative status, which can be used for the control or monitoring of a planned intervention, such as an orthopedic operation. Other interventions, such as, for example, the insertion of a tooth implant or, for example, neurosurgical interventions, can be monitored in the same manner.

The invention solves the posed problem with a method for generating a graphical 3D computer model which has the features of Claim 1.

The advantages achieved by the invention are considered substantially to be that, thanks to the method according to the invention, initially generated 3D computer models of anatomical structures, such as bones, for example, can now also always be represented spatially over the entire course of the therapy by repeated registration using the different imaging processes, such as conventional preoperative X-ray images, intraoperative planar 2D C-arc or spatial 3D C-arc images, or postoperative X-ray images. A spatial representation generated a single time and preferably preoperatively by CT is advantageous for several reasons: it generates a spatial representation of the region to be treated at the beginning of the therapy. This spatial information can then be used for the diagnosis and therapy planning. Furthermore, preoperatively, more time is available for processing and analyzing the information than, for example, during the operation. In addition, for time-related and/or technical reasons, other imaging processes generating images by intraoperative 2D or 3D C-arc imaging are less appropriate or not suitable at all for generating 3D computer models of anatomical structures, such as bones. The same also applies to conventional pre- and postoperative X-ray images in which true-to-scale representation of 3D computer models of anatomical structures such as bone fragments is not possible, or in any case is not possible without considerable additional costs. These X-ray images represent planar summation images generated from only one projection direction. However, their high image resolution is advantageous.

### DEFINITIONS

Medical 3D image data set: a medical 3D image data set of an anatomical structure to be treated of a patient, for example, of the region with a fracture or with a bone malposition is acquired advantageously by CT. Alternatively or additionally, other three-dimensional tomographic imaging processes such as cone beam computed tomography (also referred to as digital volume tomography), magnetic resonance tomography or also 3D laser scanning can also be used.

Medical 2D image data set: the term medical 2D image data set refers to a digital data set which comprises the digital data of one or more digitized planar X-ray images of an anatomical structure to be treated of a patient.

Graphical 3D computer model: the term graphical 3D computer model refers to a virtual model of objects, such as anatomical structures, temporary aids (for example, surgical instruments and tools) and implants, which can be represented on the monitor and which is defined by a digital data set. The first graphical 3D computer model can comprise several extractable graphical 3D submodels for separate anatomical structures, for example, bone fragments, for one or more implants and/or one or more surgical instruments. It is also possible for the second graphical 2D or 3D computer model to comprise several extractable graphical 3D submodels for separate anatomical structures, for example, bone fragments, for one or more implants and/or one or more surgical instruments.

Implant: the term implant usually refers to any solid means that have been inserted or are to be inserted artificially, completely or partially, into the human or animal body, and that can be represented by conventional X-ray images, CT or magnetic resonance imaging (MRI) and that vary only to a limited extent in terms of their shape, for example, orthopedic implants, dental implants, cardiac pacemakers or stents.

Image registration: the term “image registration” below refers to a superpositioning of two or more 2D representations of anatomical structures to be treated and/or of the implants used, wherein the 2D representations are made to coincide exactly with a graphical 3D computer model of the anatomical structures to be treated and/or of the implants and defined in each case by a digital data set.

In the method according to the invention, using image registration, one or more digitized medical images of the second medical 2D or 3D image data set of the anatomical structures to be treated and/or of the implants are registered using the first graphical 3D computer model, so that an updated position of the first graphical 3D computer model, i.e., a position that is adapted to the pre-, intra-, or postoperative position of the anatomical structures to be treated and/or the implants, can be represented on the monitor of a computer.

Additional advantageous embodiments of the invention can be commented on as follows:

In a special embodiment of the invention, step B) in addition comprises the substep:

B1) Introducing a digital graphical 3D submodel which represents an implant into the first graphical 3D computer model.

The graphical 3D submodel of the implant can be copied from a database such as, for example, a CAD database, into the first graphical 3D computer model.

In another embodiment of the invention, step B) additionally comprises the substep:

B2) Introducing a digital graphical 3D submodel which represents a surgical instrument into the first graphical 3D computer model.

The graphical 3D submodel of the surgical instrument can also be copied from a database, such as, for example, CAD database, into the first graphical 3D computer model.

In another embodiment of the method, the first medical 3D image data set received preoperatively in step A) comprises several anatomical structures, and the first graphical 3D computer model comprises, for each anatomical structure and preferably for each implant and/or each surgical instrument, in each case a graphical 3D submodel. In this manner, it is possible to achieve the advantage that for the anatomical structures to be treated, such as bones or bone fragments, for example, graphical 3D submodels that can be acquired individually can be integrated in the first graphical 3D computer model, so that an individual analysis of certain anatomical structures becomes possible. Furthermore, the first graphical 3D computer model can acquire graphical 3D submodels of implants and surgical instruments that can be acquired individually.

In another embodiment of the invention, the second graphical 2D or 3D computer model additionally comprises representations of one or more implants.

In yet another special embodiment of the method, the second graphical 2D or 3D computer model additionally comprises representations of one or more surgical instruments.

In another embodiment of the method, the second graphical 2D or 3D computer model for the anatomical structures and for each implant, and preferably also for each surgical instrument, comprises in each case a graphical 2D or 3D submodel.

In yet another embodiment of the method, the second graphical 2D or 3D computer model, in the implementation of the image registration, forms the reference model with which the first graphical 3D computer model is made to overlap. The second graphical 2D or 3D computer model is used as reference model and it thus defines a target model, with which the first graphical 3D computer model (object model or source model) is made to coincide. The receiving of the second medical 2D or 3D image data set can comprise one or more digitized medical images, each acquired at a predetermined angle of the image plane of the C-arm X-ray apparatus relative to the gravitational force vector, so that the position of the anatomical structures to be treated and thus the position of the first graphical 3D computer model are defined in a coordinate system that is fixed relative to the operating room.

In an additional embodiment of the method, the receiving (in a pre-, intra-, or postoperative status) of a second medical 2D or 3D image data set in step C) includes the receiving of one or more digitized medical images by means of a computer-assisted medical imaging process. The acquisition of two or more digitized medical images at an angle relative to one another allows the generation of a 3D computer model. On the other hand, different fragments and/or sections of a long bone can also be represented, each in one of the digitized medical images, so that intraoperatively used C-arm X-ray apparatuses with a relatively small field of view can be used for receiving the second medical 2D or 3D image data set. The method is characterized in that at best only one X-ray view is sufficient and the standard views “in two planes” known to the person skilled in the art can be dispensed with. Additional advantages of the method thus are reduced exposure to radiation and reduced cost. In the case of treatments of fractures and in corrective osteotomies, the entire osteosynthesis construct consisting of bone fragments, possibly a residual bone defect, and the implants used, can be spatially evaluated over the entire course of the therapy. On the computer monitor, a 3D computer model of the anatomical structure, such as the fracture or the osteotomy, becomes visible, which, depending on the stage of the therapy, spatially represents the bone fragments before, during or after the operation in follow-up checks. Here, 3D imaging is required only a single time. As soon as the implant material becomes radiologically visible, its position can also be determined spatially and represented by referencing the 3D computer models thereof using the 3D computer models of the anatomical structures, such as bone fragments, for example.

In yet another embodiment of the method, the generation of the first graphical 3D computer model comprises an automatic or manual identification and locating of anatomical landmarks, lines and/or regions of the anatomical structures to be treated.

In another embodiment of the method, the generating of the first graphical 3D computer model comprises an automatic or manual identification and locating of landmarks, lines and/or regions of each implant and preferably of each surgical instrument.

In another embodiment of the method, the generating of the second graphical 2D or 3D computer model comprises an automatic or manual reidentification or relocating of the anatomical landmarks, lines and/or regions of the anatomical structures to be treated that have been identified and located in the first graphical 3D computer model. Therefore, in the simplest case, the second graphical 2D or 3D computer model comprises a single digitized medical image with the reidentified and relocated anatomical landmarks. The image registration can therefore be carried out with a landmark-based registration process. In the landmark-based registration process, a certain number, as a rule a relatively small number, of landmarks, for example, of anatomical landmarks, is extracted from the images. This occurs either manually or automatically. The selected anatomical landmarks are preferably distributed over the entire image to the extent possible and not concentrated only in individual regions. The image registration then occurs in that the selected landmarks, for example, the selected anatomical landmarks on the object model, i.e., on the first graphical 3D computer model, are brought in agreement with the same anatomical landmarks on the reference model, or target model, i.e., on the second graphical 2D or 3D computer model. In addition to anatomical landmarks, surfaces in the image that stand out clearly from the surrounding surfaces, that is to say regional landmarks or lines or edges that are present themselves as lines or as contours of regions, can also be used as landmarks. Lines can also be represented and extracted using their end points, for example.

In an additional embodiment of the invention, the generating of the second graphical 2D or 3D computer model comprises an automatic or manual reidentification or relocating of the landmarks, lines and/or regions of each implant and each surgical instrument which have been identified and located in the first graphical 3D computer model.

The registration of the graphical 3D submodels of the implants and/or of the surgical instruments can now occur in two ways:

1) first, the graphical 3D submodel(s) of the anatomical structures of the first graphical 3D computer model is/are registered using the graphical 3D submodel(s) of the anatomical structures of the second graphical 3D computer model, and subsequently the graphical 3D submodel(s) of the implants and/or of the surgical instruments of the first graphical 3D computer model is/are registered using one or more graphical 3D submodels of the anatomical structures of the previously registered graphical 3D submodels of the anatomical structures of the first graphical 3D computer model, and in the process the relative positions between the graphical 3D submodels of the implants and/or surgical instruments and the graphical 3D submodels of the anatomical structures are taken into consideration in the second graphical 2D or 3D computer model; or

2) first, the graphical 3D submodel(s) of the anatomical structures of the first graphical 3D computer model is/are registered using the graphical 3D submodel(s) of the anatomical structures of the second graphical 3D computer model, and subsequently the graphical 3D submodel(s) of the implants and/or of the surgical instruments of the first graphical 3D computer model is/are registered using the graphical 3D submodel(s) of the implants and/or the surgical instruments of the second graphical 3D computer model.

In an additional embodiment of the method, step B) additionally comprises the substep:

Computer-assisted planning and implementation of a virtual surgical treatment of the anatomical structures to be treated using the first medical 3D image data set received in step A).

On the basis of the first medical 3D image data set of the anatomical structures to be treated, a 3D submodel of the first graphical 3D computer model can be established first, which comprises the anatomical structures and which is used for the planning and implementation of the virtual surgical treatment as initial graphical computer model. Additional 3D submodels can be established subsequently for planned therapy steps such as, for example, the repositioning of bone fragments, until the completion of the therapy, and can be integrated in the first graphical 3D computer model.

In yet another embodiment of the method, the first graphical 3D computer model comprises a graphical 3D submodel of the anatomical structures to be treated, in the form of a digital data set using the first medical 3D image data set received in step A).

In an additional embodiment of the method, the computer-assisted planning comprises the integration of at least one additional graphical 3D submodel of an implant in the first graphical 3D computer model. Thus, the position of implants and/or temporary aids, such as, for example, guide wires, surgical tools or instruments, can be determined spatially and represented in each therapy step up to the completion of the therapy. This is achieved by a comparison of the positions of corresponding 3D computer models of the implants and/or the temporary aids, which are archived in the computer and can be downloaded, first with the 3D computer models—now positioned in the correct position—of the anatomical structures (as described above) and, second, with the positions of the implants and/or temporary aids which can be seen in the X-ray images. The 3D computer models of the implants and/or temporary aids are thus now always represented spatially over the entire course of the therapy, by means of repeated registrations using the different imaging processes, such as conventional preoperative X-ray images, intraoperative planar 2D C-arc or spatial 3D C-arc images, or postoperative X-ray images.

In yet another embodiment of the method, the computer-assisted planning comprises the integration of at least one additional graphical 3D submodel of a temporary aid, preferably of a surgical instrument, in the first graphical 3D computer model.

In an additional embodiment of the method, the computer-assisted planning comprises an evaluation of the biomechanical stability of the virtually surgically treated anatomical structures by means of a computer simulation, preferably by means of a finite element computer analysis. By computer-assisted analysis and planning of the operation, i.e., the repositioning of the anatomical structure, the type and the position of the temporary and definitive implant can be represented spatially on the computer, planned virtually, and the biomechanical stability, for example, of an osteosynthesis, can be evaluated by computer simulation and reevaluated in each therapy step. Depending on the situation, the therapy plan can then be continued or modified if needed.

In an additional embodiment of the method, the first graphical 3D computer model comprises at least one graphical 3D submodel of at least one intermediate result of the anatomical structures virtually treated in accordance with the computer-based planning.

In another embodiment of the method, the first graphical 3D computer model comprises an implementation plan as submodel, which preferably defines the exact course of the surgical intervention and contains corresponding control specifications.

The method can be used for monitoring surgical treatments. It is preferable for step C) of the method to occur first in a preoperative status, so that monitoring of the at least one object becomes possible prior to the surgical intervention. Step C) of the method can occur in at least one intraoperative status, so that monitoring of the at least one object during the surgical treatment becomes possible. Furthermore, step C) can also be carried out in at least one postoperative status, so that monitoring of the at least one object after the surgical treatment becomes possible.

It is preferable for the method according to the invention to be used for the quality assurance of surgical treatments. An additional component and advantage of the method is that all the data generated throughout the entire course of the therapy can be integrated in a quality management system and thus analyzed. This in turn can have a positive effect on the type, selection and implementation of the therapy; for example, it can standardize the therapy procedure based on the applicable parameters.

The method can be used for treating bone fractures, for treating bone malpositions, and in dental implantology.

The invention and variants of the invention are described in further detail below in reference to the partially diagrammatic representations of several embodiment examples.

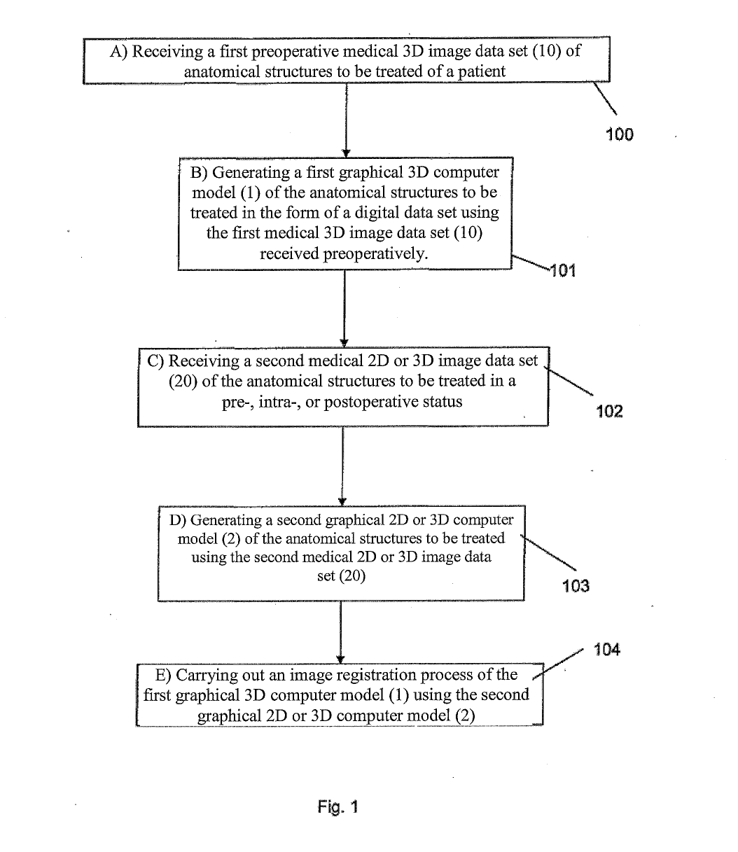

FIG. 1 shows a flow chart of an embodiment of the method according to the invention;

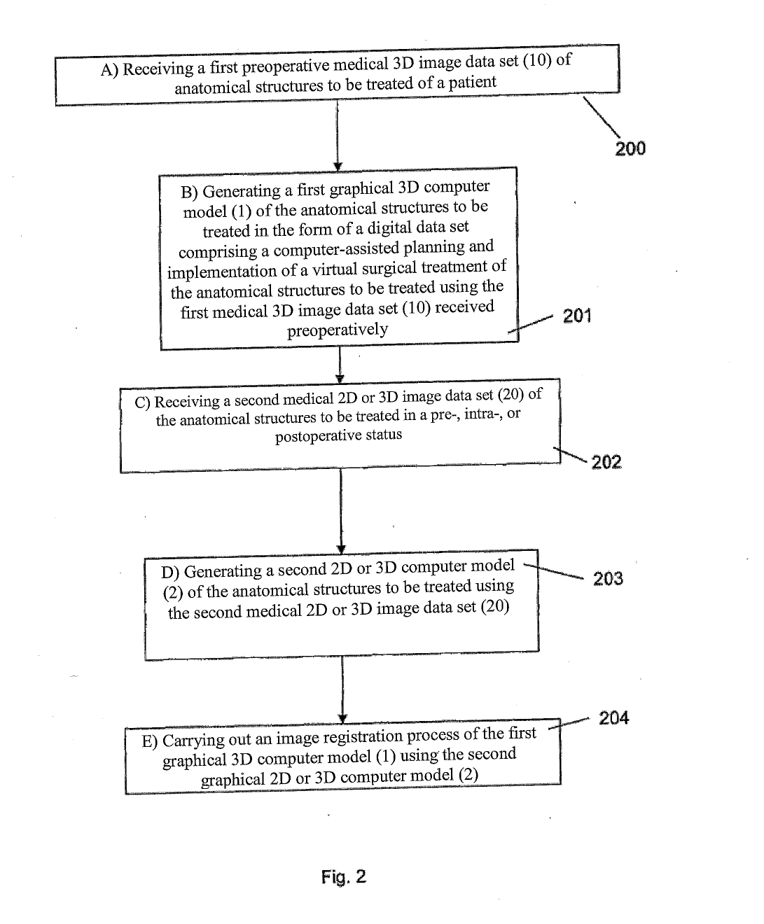

FIG. 2 shows a flow chart of an additional embodiment of the method according to the invention; and

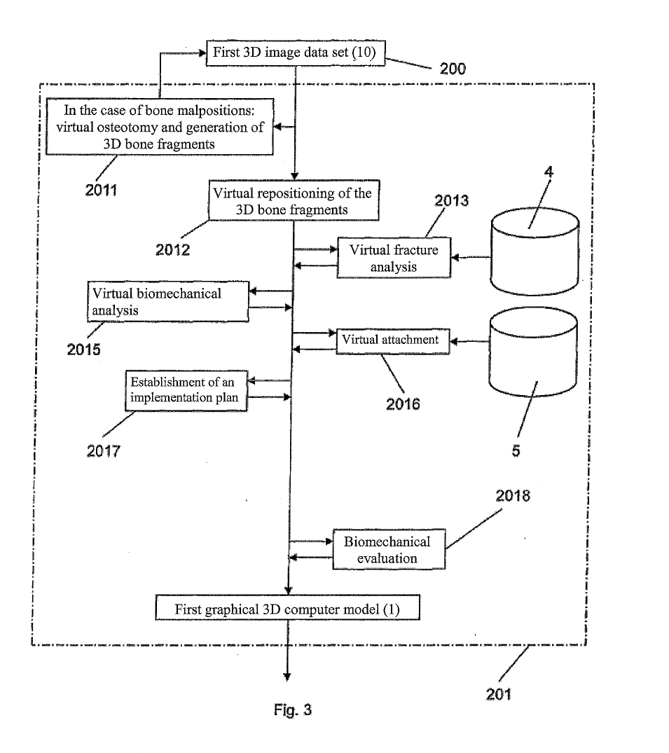

FIG. 3 shows a flow chart of an embodiment of the generating of a first graphical 3D computer model according to the embodiment of the method according to the invention according to FIG. 2.

In principle, the method according to the invention can be used for any anatomical structures that can be acquired three-dimensionally by a computer-assisted medical imaging process. In addition, it is possible to use any implants and intraoperatively usable surgical instruments that can be acquired at least partially in a geometrically clear manner by means of a computer-assisted medical imaging process.

### EXAMPLE 1

Below, the method according to the invention is described as an example in a surgical treatment of bone fractures and in a correction of bone malpositions.

The embodiments represented in FIGS. 1 and 2 differ only in that, in the embodiment according to FIG. 1, a first graphical 3D computer model 1 of anatomical structures to be treated is established on the basis of a preoperative first medical 3D image data set 10, while in the embodiment according to FIG. 2, a graphical 3D computer model established analogously to the embodiment according to FIG. 1 is used as graphical 3D submodel, and the generating of the first graphical 3D computer model 1 additionally comprises a computer-assisted planning and implementation of a virtual surgical treatment of the anatomical structures to be treated using this 3D submodel. The embodiment of the method according to FIG. 1 can be used in particular, for example, in emergencies, such as in serious accidents, when for time-related reasons, a computer-assisted planning of the operation cannot be carried out. In addition, in the embodiment of the method according to FIG. 2, for monitoring the entire course of the therapy, all the necessary pre-, intra-, or postoperatively image registrations can be carried out using the embodiment according to FIG. 1 or the embodiment according to FIG. 2.

The embodiment of the method represented in FIG. 1 substantially comprises the steps:

Step 100: 3D imaging before surgery

First, the receiving of a preoperative first medical 3D image data set 10 of anatomical structures to be treated of a patient by means of a computer-assisted medical imaging method. The method includes the obtention of adequate image information of the field of operation before the surgery. This provides for generating a preoperative first medical 3D image data set of an anatomical structure to be treated of a patient, for example, of the region with fracture or with bone malposition, preferably by CT. Alternatively or in addition, other three-dimensional cross-sectional imaging methods such as cone beam computed tomography (also referred to as digital volume tomography), magnetic resonance tomography or 3D laser scanning can also be used. As output, the preoperative first medical 3D image data set 10 is obtained in the form of a digitized 3D image data set, for example, in the form of a data set in DICOM format (Digital Imaging and Communication in Medicine).

Step 101: Generating a first graphical 3D computer model 1 of the anatomical structure to be treated, in the form of a digital data set using the first medical 3D image data set 10 received in step 100. In particular, in this step, identification, locating and representation of the anatomical structures before the operation occur.

Using the preoperative first medical 3D image data set 10, which was generated preferably by preoperative CT, the anatomical structures to be treated, such as, for example, bone fragments in the case of fractures or bone segments in the case of bone malpositions, are identified using appropriate computer software, located, and stored in the form of a first graphical 3D computer model 1, so that said structures can be represented, for example, as 3D bone fragments, on a monitor. This can be done using methods of identification, for example, recognition of anatomical geometric patterns of the anatomical structures, for example, of the bone structures; their locating, i.e., the definition of their spatial position; and their representation, i.e., their adequate spatial representation as 3D computer model. This also includes techniques of image segmentation. For example, in the case of corrective osteotomies, in this step 101, two or more virtual bone fragments, depending on the osteotomy plan, are already identified and located, wherein a prospective section line is used for the separation of the bone fragments. Step 101 is carried out before the operation, automatically and/or manually, on a computer, wherein, as input, the preoperative first medical 3D image data set 10 received in step 100, and computer software and methods are used for processing this 3D image data set, i.e., for the identification, locating and spatial representation of the 3D anatomical structures such as, for example, bone fragments in the case of fractures. As output, a processed digital data set is obtained, which allows a graphical 3D representation of the anatomical structures, for example, of the individual bone fragments.

The first graphical 3D computer model 1 of the anatomical structures to be treated, obtained in step 101, can now be made to coincide in terms of its spatial position by image registration with a second graphical 2D or 3D computer model 2, which is generated from one or more digitized medical images of a pre-, intra-, or postoperatively received second or additional medical 2D or 3D image data set 20. As a result, the first graphical 3D computer model 1 can be represented on the monitor of a computer throughout the entire course of the therapy, in the updated position, i.e., in the actual pre-, intra-, or postoperative position of the anatomical structures to be treated. While monitoring a surgical treatment, the first graphical 3D computer model 1 can therefore be used for the representation in the correct position of the anatomical structures to be treated, preoperatively in the operating room immediately before the operation, intraoperatively, after the completion of the operation, and/or postoperatively for the follow-up check. For this purpose, the steps 102 to 104 described below are carried out in each case.

Alternatively—as described below under FIG. 2—the generation of the first graphical 3D computer model 1, which is described in step 201, can additionally comprise computer-assisted planning and implementation of a virtual surgical treatment of the anatomical structures to be treated, using the first medical 3D image data set 10 received in step 200. For monitoring a surgical treatment, the image registration of the first graphical 3D computer model 1 can in this case be carried out in accordance with one of the embodiments according to FIG. 1 or according to FIG. 2 using one or more digitized medical images of a pre-, intra-, or postoperatively received second or additional medical 2D or 3D image data set 20.

Step 102: Before the image registration of the first graphical 3D computer model 1 according to one of the embodiments according to FIG. 1 or according to FIG. 2 using a second graphical 2D or 3D computer model 2, the receiving occurs—in the desired pre-, intra-, or postoperative status—of a second medical 2D or 3D image data set 20, which comprises one or more digitized medical images 21, of the anatomical structures to be treated and/or of the implants, by means of a computer-assisted medical imaging method.

Step 103: Subsequently, the generating of a second graphical 2D or 3D computer model 2 of the anatomical structures to be treated occurs, in the form of a digital data set using the second medical 2D or 3D image data set 20 received in step 102. After the one or more digitized medical image(s) have been received, for example, by pre-, intra-, or postoperative X-ray imaging of the anatomical structures to be treated, the same anatomical landmarks of the anatomical structures, for example, bone fragments and bone contours of the fracture zone and of the healthy bone surface including the joint surface, bone gray values and/or geometric bone patterns, are reidentified and relocated on the one or more digitized medical images or directly in the second graphical 2D or 3D computer model 2, in order to subsequently register the first graphical 3D computer model 1 of the anatomical structures to be treated, for example, the bone fragments, using the second graphical 2D or 3D computer model 2 of the pre-, intra-, or postoperative situation. As pre-, intra-, or postoperative imaging techniques, a conventional planar X-ray view or X-ray views in two planes are used, or X-ray images generated in the operating room immediately before the operation, preferably by means of a 2D or 3D imaging process using a C-arc X-ray apparatus.

Step 104: Subsequently, the implementation of the image registration of the first graphical 3D computer model 1 is carried out using the second graphical 2D or 3D computer model 2. Consequently, a new representation is produced, in which the first graphical 3D computer model 1 of the anatomical structures to be treated, for example, of the bone fragments, is visible in the correct position in accordance with the current imaging. Any shifts in the position of the anatomical structures, for example, of the bone fragments, from the time of the computer tomography (CT) acquisition are accordingly updated and thus compensated.

The embodiment of the method represented in FIG. 2 differs from the embodiment represented in FIG. 1 only in that the generating of the first graphical 3D computer model 1 can comprise a computer-assisted planning and implementation of a virtual surgical treatment of the anatomical structures to be treated in the case of a possible use of implants and also of surgical instruments.

The embodiment of the method represented in FIG. 2 is described, using the example of an osteosynthesis or of a corrective osteotomy, and it comprises substantially the steps:

Step 200: 3D imaging before operation:

First, analogously to the embodiment according to FIG. 1, the receiving of a preoperative first medical 3D image data set 10 of the anatomical structures to be treated of a patient occurs by means of a computer-assisted medical imaging process.

Step 201: Subsequently, the first graphical 3D computer model 1 of the anatomical structures to be treated is generated in the form of a digital data set, wherein the generating of the first graphical 3D computer model 1 comprises a computer-assisted planning and implementation of a virtual surgical treatment of the anatomical structures to be treated, using the first medical 3D image data set 10 received in step 100. Analogously to FIG. 1, in this step, first identification, locating and representation of the anatomical structures before the operation occurs.

The 3D preoperative planning on the computer is represented in detail in FIG. 3, wherein the 3D preoperative planning on the computer can comprise all or only some of the steps 2011 to 2021 represented in FIG. 3. As auxiliary to the clinical examination of the patient and to a study of the clinical documents including an evaluation of the imaging, a preoperative planning of the surgical intervention on the computer is now carried out additionally using appropriate software: Here, for example, an anatomically correct virtual repositioning of the 3D bone fragments represents a central task (step 2012), in the case of bone fractures. The anatomical repositioning of the 3D bone fragments also allows the representation and analysis of any residual bone defect present. On the other hand, in the case of bone malpositions, the osteotomy is spatially established virtually on the computer (step 2011) and then the 3D bone fragments are shifted into the planned position (step 2012). For this purpose, the above-established 3D bone fragments are continually newly represented, or registered, in accordance with the planned position of the osteotomy.

As an additional feature of this 3D preoperative planning on the computer, the fracture or the osteotomy can be analyzed virtually (step 2013). Thus, for example, the shape, size and degree of dislocation of the bone fragments and residual defect or created defect, as well as any occurring overlapping of the bone fragments (important in the case of osteotomies or bone transplantation) can be calculated. In the process, it is also possible to use known fracture classifications 4, for example, the AO COIAC classification, or the Müller AO classification, which are stored in databases and can be downloaded.

Then, the virtual osteosynthesis (step 2016), in the case of fractures and also bone malpositions, can be planned by selecting 3D computer models 5 of temporary aids archived in the computer, for example, of surgical instruments and defined implants such as plates, marrow nails, screws, guide wires, in the appropriate size and positioned in the first graphical 3D computer model as graphical 3D submodels. In the case of bone defects, the planning of an autologous or alloplastic material (for example, bone transplant or cement), including the quantity, can be taken into account additionally by representing the defect virtually with corresponding virtual filling substances which correspond to the volume or to the mechanical properties of the bone. As an additional feature of step 201, an implementation plan (step 2017) is established and integrated as submodel in the first graphical 3D computer model 1, which defines the exact sequence of the surgical intervention and contains appropriate control specifications. Thus, the sequence of the repositioning of the bone fragments or osteotomies is established, as is the sequence and use of the temporary aids and of the definitive implants. The control specifications include a virtual graphical 3D computer model of the intermediate result, which can be compared during the operation to the actual intermediate result.

As an additional feature of step 201, the osteosynthesis consisting of bone fragments and implant, which is created during the virtual operation planning, can be biomechanically tested virtually (step 2018), for example, by finite element analysis.

As input, the preoperative first medical 3D image data set 10 received in step 200 is used, wherein, on the basis thereof, before the planning, graphical 3D submodels of the bone fragments or of the entire region in the case of bone malpositions can be produced. For the planning and implementation of a virtual surgical treatment, the following software tools can be used:

1. software tool for generating virtual osteotomies, in particular in the case of bone malpositions;

2. software tool for the virtual repositioning of the 3D bone fragments;

3. archived 3D computer templates of temporary aids and definitive implants such as plates, screws, marrow nails, Kirschner wires;

4. software tool for analyzing the components (such as the number, size, geometry of the bone fragments and implants) and the planning processes (for example, degree of dislocation, osteotomy angle) during the planning;

5. software tool for the establishment of a primary implementation plan and of alternatives; and

6. software tool for the analysis of the biomechanical properties of the osteosynthesis.

As output, a first graphical 3D computer model 1 is produced, which can comprise the anatomical structures virtually treated surgically in accordance with the computer-based planning with the implants and/or surgical instruments, one or more graphical 3D submodels of one or more intermediate results of the anatomical structure treated virtually in accordance with the computer-based planning, and the computer-based planning of the osteosynthesis for treating fractures or correcting bone malpositions.

Step 202: Receiving—in the desired pre-, intra-, or postoperative status—a second medical 2D or 3D image data set 20 of the anatomical structures to be treated, of the implants and of the surgical instruments, which comprises one or more digitized medical images 21, by means of a computer-assisted medical imaging method analogous to FIG. 1.

Step 203: Generating a second graphical 2D or 3D computer model 2 of the anatomical structures to be treated and/or of the implants, in the form of a digital data set using the second 2D or 3D image data sets 20 received in step 202, analogously to FIG. 1. After the one or more digitized medical images 21 have been generated, for example, by pre-, intra-, or postoperative X-ray imaging of the anatomical structures to be treated with the implant and/or surgical instruments, anatomical landmarks of the anatomical structures, for example, of bone fragments and bone contours of the fracture zone and of the healthy bone surface including the joint surface, bone gray values and/or geometric bone patterns, are reidentified and relocated on the one or more digitized medical images 21 or directly in the second graphical 2D or 3D computer model 2, in order to subsequently register the first graphical 3D computer model 1 using the second graphical 2D or 3D computer model 2. As preoperative imaging techniques, conventional planar X-ray imaging or X-ray imaging in two planes is used, or X-ray images generated in the operating room immediately before the operation preferably by means of a 2D or 3D imaging process using a C-arc X-ray apparatus.

Step 204: Subsequently, the image registration of the first graphical 3D computer model 1 is carried out using the second graphical 2D or 3D computer model 2. As in the case of image registration in accordance with the embodiment according to FIG. 1, a new graphical representation is produced, in which the first graphical 3D computer model 1 of the anatomical structures to be treated, for example, of the bone fragments, is visible in the correct position in accordance with the current imaging. Any possible shifts in the position of the anatomical structures, for example, of the bone fragments, from the time of the computer tomography (CT) acquisition are accordingly updated and thus compensated. As soon as implants and/or surgical instruments are visible radiologically or by another imaging process, their position can be determined spatially and represented by referencing of their graphical 3D submodels using the graphical 3D submodel(s) of the anatomical structures, such as bone fragments, for example. In addition, the entire planned implant including the position and its direction of insertion and final position can be visualized. Thus, in step 204, a prospective spatial position determination of the temporary aids and/or of the definitive implant occurs also preoperatively. After the registration of all the described components, the different components can respectively be represented on the computer or masked.

The embodiments of the method according to the invention that are described in FIGS. 1 to 3 can be used subsequently for the three-dimensional (3D) monitoring of a surgical treatment. In the process, the 3D monitoring can comprise one or more of the steps listed below:

1) Monitoring before the operation; and/or

2) Monitoring during the operation; and/or

3) Monitoring during postoperative follow-up checks.

### 1) Monitoring Before the Operation:

At the beginning, in accordance with step 102 or 202, a second medical 2D or 3D image data set 20, for example, a preoperative X-ray image of the anatomical structures to be treated is received. Anatomical landmarks of bone fragments and bone contours of the fracture zone and healthy bone surface including the joint surface, bone gray values and also geometric bone patterns are reidentified and relocated on the preoperative X-ray image in order to register the first graphical 3D computer model 1 of the bone fragments using the second graphical 2D or 3D computer model 2. As preoperative imaging techniques, one uses the conventional planar X-ray views or X-ray views in two planes, or also X-ray images generated in the operating room immediately, before the operation, preferably by means of 2D C-arc or 3D C-arc imaging.

Consequently, a new representation is produced, in which the first graphical 3D computer model 1 of the anatomical structures, for example, of the bone fragments, is visible in the correct position according to the current imaging. Any shifts in the position of the bone fragments from the time of the CT acquisition are accordingly updated and thus compensated.

Now, the 3D operation planning can be taken into consideration, i.e., the entire planned osteosynthesis construct can be visualized, including the position of implants and their direction of insertion and final position. Thus, preoperatively, a prospective spatial position determination of implants also occurs. After registration of all the described components, the various components can respectively be represented on the computer or masked.

### 2) Monitoring During the Operation:

A new X-ray image check occurs, but now intraoperatively during the operation, preferably a 2D or 3D C-arc image check. In the same way, a new image registration as described under step 204 above occurs. Thus, anatomical landmarks of bone fragments and bone contours of the fracture zone and healthy bone surface including the joint surface, bone gray values and also geometric bone patterns are reidentified and relocated in the intraoperative X-ray image, in order to register the first graphical 3D computer model 1 of the bone fragments. Thus, intraoperatively, the current position of the 3D bone fragments can be spatially determined or monitored. If, at the beginning of the operation, an implant is attached to the bone, this can improve or facilitate the registration process. This can be advantageous particularly in corrective osteotomies, since fewer anatomical landmarks are available here, which analogously can also be identified in the preoperative 3D imaging.

In the case of corrective osteotomies, it can be advantageous first to carry out only a partial shift in order to spatially evaluate the position of the bone fragments by reidentification and relocating. Further measures can then be instituted in order to improve the osteotomy result. It is only after the check of the spatially correct position of the bone fragments that the definitive attachment occurs.

As soon as implants and/or surgical instruments become visible over the course of the operation in an additional intraoperative X-ray image check, their spatial position can also be determined by registering them using the already spatially defined graphical 3D computer model 1 of the bone fragments and corresponding positioning of graphical 3D submodels of the implants and/or surgical instruments.

Now, the 3D operation planning according to step 201 can again be taken into consideration, i.e., the planned and current osteosynthesis, including the position of implants and/or surgical instruments and their direction of insertion and final position, can be visualized, analyzed and biomechanically tested virtually.

Further X-ray image checks with new reidentification and relocating during the operation and the inclusion of information from the preoperative planning and simulation help the surgeon to successfully continue the operation and document it three dimensionally, to modify it, and finally complete it with a check of the spatial position of the osteosynthesis.

### 3) Monitoring in Postoperative Follow-Up Checks.

Postoperative follow-up checks with X-ray checks are carried out routinely. In said X-ray checks, the first graphical 3D computer model 1 of the bone fragments and also the graphical 3D submodels of the implants after osteosynthesis can be reidentified and relocated as desired. Thus, in the postoperative X-ray checks, it is possible to determine whether and when a change in the spatial position of the bone fragments or the implants has taken place; in particular whether a change has taken place postoperatively. Again, the position of the first graphical 3D computer model 1 of the bone fragments and of the implants can be compared to the graphical 3D computer models 1 established pre- or intraoperatively. The computerized preoperative planning can be overlaid, and the current situation can be simulated, for example, by finite element analysis, in order to test the biomechanical stability of the current osteosynthesis. In further follow-up checks, a reevaluation occurs, i.e., a decision is made on the basis of the represented results to determine whether the therapy should be terminated or whether new diagnostic or therapeutic steps should be instituted.

If a precise registration is successfully achieved with just a planar X-ray image, then it is possible to dispense with the standard X-ray documentation “in two planes.” Thus, the exposure to radiation and the costs can be reduced.

The embodiments of the method according to the invention that are represented in FIGS. 1 and 2 and one or more of the findings and results obtained during the steps carried out during the monitoring can be transferred to a quality management system for surgical treatments.

### EXAMPLE 2

Below, the method according to the invention represented in FIGS. 1 to 3 is represented in an additional example for applications in tooth implantology. The course of the therapy during the insertion of one or more tooth implants can be monitored over the course of the therapy as follows: preoperatively, a 3D imaging of the field of operation and the adjacent region occurs, for example, of the adjacent teeth and/or the alveolar ridge, i.e., the receiving of a preoperative first medical 3D image data set 10 and the generating of the first graphical 3D computer model 1 or of a submodel thereof (steps 100 and 101 FIG. 1 or steps 200 and 201 in FIG. 2). Advantageously, the 3D imaging occurs by means of an optical 3D scanning method, for example, by laser scanning. This imaging can be carried out alone or as a complement to the preoperative CT or digital volume tomography. The monitoring of the individual therapy steps now takes place by acquiring the field of operation before and then during the operation, including the surgical instruments, such as the pilot drill or the dental implant, and also immediately after the operation or after the incorporation of the dental prosthetic work (i.e., crown or bridge) by means of optical laser scanning including the adjacent region, and these imaging views generated in different therapy stages are registered. The 3D imaging views described above form a second graphical 3D computer model as well as additional graphical 3D computer models 2, which are generated on the basis of a second medical 3D image data set as well as additional medical 3D image data sets 20 (steps 102 and 103 in FIG. 1 or steps 202 and 203 in FIG. 2) and are registered using the first graphical 3D computer model 1 (step 104 in FIG. 1 or step 204 in FIG. 2). This registration should preferably be carried out on structures that have not been operated on, for example, on anatomical structures, such as teeth or the alveolar ridge. The registration allows the determination of the spatial position of the implants and surgical instruments. As described, steps of the 3D preoperative planning (step 201 in FIG. 2) can be included in the therapy. Also, the result of the therapy, for example, the entire dental prosthetic treatment, can be compared with the virtual planning or reevaluated in any phase.

The advantage of this variant of the invention is that laser scanning is a 3D imaging process which generates no X-rays. This laser scanning can be used as soon as surfaces of the operation region as well as implants, surgical instruments, but also fracture segments or osteotomies are visible to a sufficient extent and can thus be detected. Advantageously, no additional exposure of the patient to X-rays occurs over the course of the therapy. Furthermore, the highly detailed rendition of surfaces, such as the surfaces of the teeth or implants, is advantageous.

However, alternatively, in the field of tooth implantology, as described, conventional dental X-ray views can also be used for monitoring over the course of the therapy. Here, although there is exposure to X-rays, it is minor. If the implants or surgical instruments are not sufficiently visible directly, because they are located in the bone and/or under the mucosa and can thus not be detected or detected only insufficiently directly by laser scanning, then temporary bodies with known geometries, for example, a healing cap, can be attached by screw connection to the implants or surgical instruments. If the operated region is now scanned with an easily visible healing cap for each inserted implant, then the corresponding computer template of the healing cap can subsequently also be taken into consideration in the registration along with the computer template of the inserted implant or surgical instrument, which is attached thereto, and thus its position can be determined clearly.

Although there are various embodiments of the present invention, as described above, it should be understood that their various features can be used either individually or also in any desired combination.

Therefore, the invention is not limited simply to the above-mentioned, particularly preferable embodiments.

1. A method for generating a graphical 3D computer model of at least one anatomical structure in a selectable pre-, intra-, or postoperative status, the method comprising steps:
A) receiving a first preoperative medical 3D image data set of at least one anatomical structure to be treated of a patient, by means of a computer-assisted medical imaging process;
B) receiving a first graphical 3D computer model of the anatomical structure to be treated, in the form of a digital data set using the first medical 3D image data set received in step A);
C) receiving a second medical 2D or 3D image data set of the anatomical structures to be treated, in a pre-, intra-, or postoperative status, by means of a computer-assisted medical imaging process;
D) generating a second graphical 2D or 3D computer model of the anatomical structures to be treated, in the form of a digital data set using the second medical 2D or 3D image data set received in step C); and
E) carrying out an image registration process of the first graphical 3D computer model using the second graphical 2D or 3D computer model.

2. The method according to claim 1, wherein step B) additionally comprises the substep:
B1) introducing a digital graphical 3D submodel which represents an implant into the first graphical 3D computer model.

3. The method according to claim 1, wherein step B) additionally comprises the substep:
B2) introducing a digital graphical 3D submodel which represents a surgical instrument into the first graphical 3D computer model.

4. The method according to claim 2, wherein the first medical 3D image data set received preoperatively in step A) comprises several anatomical structures, and the first graphical 3D computer model for each anatomical structure and for the implant comprises a graphical 3D submodel in each case.

5. The method according to claim 1, wherein the second graphical 2D or 3D computer model additionally comprises representations of one or more implants.

6. The method according to claim 1, wherein the second graphical 2D or 3D computer model additionally comprises representations of one or more surgical instruments.

7. The method according to claim 5, wherein the second graphical 2D or 3D computer model for the anatomical structures and for each implant comprises a 2D or 3D submodel in each case.

8. The method according to claim 1, wherein, in the implementation of the image registration, the second graphical 2D or 3D computer model forms the reference model with which the first graphical 3D computer model is made to coincide.

9. The method according to claim 1, characterized in that wherein in step C) the receiving of a second medical 2D or 3D image data set in a pre-, intra-, or postoperative status comprises the receiving of one or more digitized medical images by means of a computer-assisted medical imaging process.

10. The method according to claim 1, characterized in that wherein the generating of the first graphical 3D computer model comprises an automatic or manual identification and locating of anatomical landmarks, lines and/or regions of the anatomical structures to be treated.

11. The method according to claim 10, wherein the generating of the first graphical 3D computer model comprises an automatic or manual identification and locating of landmarks, lines and/or regions of each implant.

12. The method according to claim 1, wherein the generating of the second graphical 2D or 3D computer model comprises an automatic or manual reidentification or relocating of the anatomical landmarks, lines and/or regions of the anatomical structures to be treated, which have been identified and located in the first graphical 3D computer model.

13. The method according to claim 12, wherein the generating of the second graphical 2D or 3D computer model comprises an automatic or manual reidentification or relocating of the landmarks, lines and/or regions of each implant and of each surgical instrument, which have been identified and located in the first graphical 3D computer model.

14. The method according to claim 1, wherein step B) additionally comprises the substep:
computer-assisted planning and implementation of a virtual surgical treatment of the anatomical structures to be treated, using the first medical 3D image data set received in step A).

15. The method according to claim 14, wherein the first graphical 3D computer model comprises a graphical 3D submodel of the anatomical structures to be treated, in the form of a digital data set using the first medical 3D image data set received in step A).

16. The method according to claim 14, wherein the computer-assisted planning comprises the integration of at least one additional graphical 3D submodel of an implant in the first graphical 3D computer model.

17. The method according to claim 14, wherein the computer-assisted planning comprises the integration of at least one additional graphical 3D submodel of a temporary aid in the first graphical 3D computer model.

18. The method according to claim 14, wherein the computer-assisted planning comprises an evaluation of the biomechanical stability of the virtually surgically treated anatomical structures by means of a computer simulation.

19. The method according to claim 14, wherein the first graphical 3D computer model comprises at least one graphical 3D submodel of at least one intermediate result of the anatomical structures virtually treated in accordance with the computer-based planning.

20. The method according to claim 14, wherein the first graphical 3D computer model comprises, as submodel, an implementation plan which preferably defines the exact course of the surgical intervention and which contains corresponding control specifications.

21. A method for monitoring surgical treatments using the method according to claim 1.

22. The method according to claim 21, wherein step C) occurs in a preoperative status, so that monitoring of the at least one object before the surgical treatment becomes possible.

23. The method according to claim 21, wherein step C) occurs in at least one intraoperative status, so that monitoring of the at least one object during the surgical treatment becomes possible.

24. The method according to claim 21, wherein step C) occurs in at least one postoperative status, so that monitoring of the at least one object after the surgical treatment becomes possible.

25. Use of the method according to claim 21 for the quality assurance of surgical treatments.

26. Use of the method according to claim 1 for treating bone fractures.

27. Use of the method according to claim 1 for treating bone malpositions.

28. Use of the method according to claim 1 in dental implantology.
